(19) United States
(12) Patent Application Publication
(10) Pub. No.: US 2016/0144917 A1
(43) Pub. Date: May 26, 2016

(54) MULTI-DIRECTIONAL BICYCLE LIGHTS AND ASSOCIATED MOUNTING SYSTEMS AND METHODS

(71) Applicant: Orfos, LLC, Auburn, WA (US)

(72) Inventor: Peter Daniel Clyde, Kirkland, WA (US)

(21) Appl. No.: 14/947,314

(22) Filed: Nov. 20, 2015

Related U.S. Application Data
(60) Provisional application No. 62/082,990, filed on Nov. 21, 2014.

(51) Int. Cl. B62J 6/00; F21V 23/04; F21V 21/096; F21S 9/02

(52) U.S. Cl. CPC B62J 6/001; F21S 9/02; F21V 23/04; F21V 21/096; F21Y 2101/02

(57) ABSTRACT

Multi-directional bicycle lights and associated mounting systems and methods are disclosed. A portable light source in accordance with a particular embodiment includes an elongated generally transparent outer shell, at least one light-emitting device positioned within the outer shell, and a battery positioned within the outer shell and operatively coupled to the light emitting device. The outer shell can be positioned to guide light from the light-emitting device around the outer shell and out of an external surface of the outer shell. Open space within the outer shell can be filled with a generally transparent potting material. A mounting system for portable light sources can include a magnet within the light source and a magnet attached to a support structure, with the magnets configured to attract or repel each other.

### CROSS-REFERENCE TO RELATED APPLICATION

The present application claims priority to U.S. Provisional Patent Application No. 62/082,990, filed Nov. 21, 2014, which is incorporated herein in its entirety by reference.

### TECHNICAL FIELD

The present technology is directed generally to multi-directional bicycle lights and associated mounting systems and methods.

### BACKGROUND

Existing portable light sources, such as typical bicycle lights, can provide visibility for bicyclists and other users to enhance safety. For example, a rear-mounted bicycle light can alert motorists to the presence of a bicyclist on the road and a forward-mounted bicycle light can project a beam of light to allow a bicyclist to navigate in darkness. A forward-mounted white light can also serve to alert motorists of the presence of a bicyclist.

Existing portable light sources suffer from several drawbacks. For example, some bicycle lights project a focused beam that does not shine to the sides or backwards, so side or rear traffic has difficulty seeing the user. Further drawbacks associated with existing portable light sources include insufficient battery life, insufficient weatherproofing or weather resistance, and inconvenient mounting options. Accordingly, there remains a need for more visible, versatile, and durable bicycle lights.

### BRIEF DESCRIPTION OF THE DRAWINGS

FIG. 1 is a side view of a portable light source configured in accordance with an embodiment of the present technology.

FIG. 2 is a cross-sectional view through line 2-2 of FIG. 1 configured in accordance with an embodiment of the present technology.

FIG. 3 is a front view of a portable light source configured in accordance with an embodiment of the present technology.

FIG. 4A is a side view of a portable light source having a lens in accordance with an embodiment of the present technology.

FIG. 4B is a partially schematic cross-sectional view of a portable light source having a lens in accordance with an embodiment of the present technology.

FIGS. 5A-5B are side views of mounting arrangements and systems for portable light sources in accordance with further embodiments of the present technology.

FIG. 6 is a side view of a bicycle having portable light sources mounted in accordance with an embodiment of the present technology.

FIGS. 7 and 8 are side views of helmets having portable light sources mounted in accordance with embodiments of the present technology.

### DETAILED DESCRIPTION

The present technology is directed to bicycle lights and other portable light sources that emit light in multiple directions. In particular embodiments, the multi-directional light emission is a result of internal reflection and refraction through and around a generally transparent outer shell. The present technology also includes mounting systems for bicycle lights and/or other portable light sources.

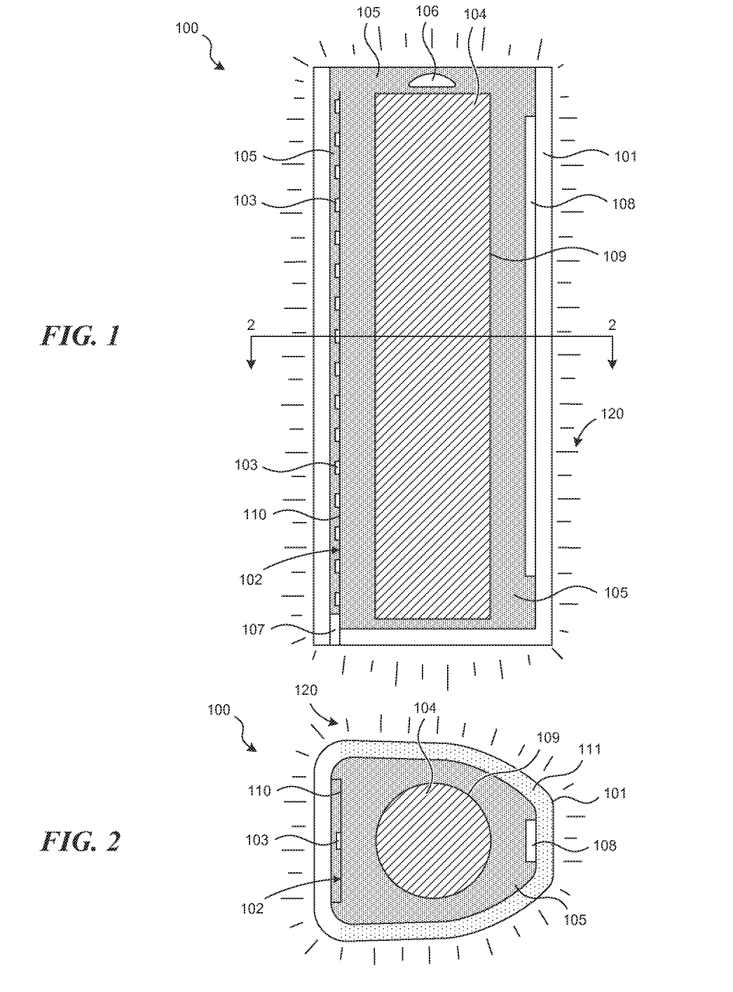

Specific details of several embodiments of the present technology are described below with reference to bicycle lights that include LEDs, transparent outer shells, silicone potting material, and magnets to provide a thorough understanding of these embodiments. In other embodiments, the lights can be used with devices other than bicycles, and/or in environments other than bicycling environments. Several details describing structures or processes that are well-known and often associated with other types of electronic devices or mounting systems are not set forth in the following description for purposes of clarity. Moreover, although the following disclosure sets forth several embodiments of different aspects of the present technology, several other embodiments of the technology can have different configurations or different components than those described in this section. As such, the technology may have other embodiments with additional elements and/or without several of the elements described below with reference to FIGS. 1-8.

### Portable Light Sources

FIGS. 1-3 illustrate a portable light source 100 with multi-directional light visibility or light emission in accordance with an embodiment of the present technology. As further described herein, the portable light source 100 can emit multi-directional light 120, e.g., from the sides, top, and/or bottom because of internal reflection and refraction through and around the materials that form the light source 100.

FIG. 1 illustrates a side view of the portable light source 100. The portable light source 100 can have an elongated outer shell 101 formed primarily from a generally transparent material, which may be an optically clear or highly translucent plastic or glass. In a particular embodiment, the outer shell 101 can include or be formed from an optically clear polycarbonate. In other embodiments, the outer shell 101 can be tinted or colored to affect the color of the emitted light. The outer shell 101 can be shaped like an open can, having a generally closed end, an open end, and rounded sides. The top can be sealed or covered with additional transparent material such as polycarbonate. In a particular embodiment, the outer shell 101 can be approximately 73.5 mm tall, 23.5 mm wide, and 28.5 mm deep, and in other embodiments, it can have other suitable dimensions. Depending on the size and shape of the internal electronics (and batteries if present), the dimensions may be more rounded/cylindrical or rectangular/prismatic.

The outer shell 101 can contain a circuit board 102, which carries one or more light-emitting diodes (LEDs) 103 or other light emitters, such as light bulbs, any of which may be arranged in a group, e.g., a strip. In some embodiments, the LEDs 103 can be diffused-type LEDs (e.g., LEDs having a coating or covering to diffuse or scatter light into wider viewing angles). In other embodiments, they may not be diffused. In various embodiments, the LEDs can be white or colored, or they can emit white or colored light to change the color of light emitted from the light source 100. In some embodiments, the LEDs can have an approximately 120 degree beam angle. In other embodiments, the LEDs can have other suitable beam angles. The outer shell 101 can also accommodate a battery 104 to power the light source 100 and a power button 106 to control functions of the light source 100.

The battery 104 can be rechargeable, e.g., a LiFePO4 type battery, which can be recharged or cycled hundreds or thousands of times and is a comparatively safer and more robust high-capacity battery. In other embodiments, the battery 104 can be another type of lithium ion battery, a lithium polymer battery, a NiMH battery, another type of rechargeable battery, or a non-rechargeable battery. One or more batteries 104 can be included in a single light source 100, e.g., depending on electronic requirements and power demands. If the battery 104 is rechargeable, it can be recharged using a charging port or interface 107, e.g., a Universal Serial Bus (USB) charging interface (for example, a standard, mini, or micro USB). In other embodiments, the charging interface 107 can be a coaxial charging interface or another suitable charging interface. In still further embodiments, the charging interface 107 can be wireless or inductive.

In particular embodiments, the battery 104 is rated at 3.2 volts and the light source 100 can include circuitry to boost the light source voltage to approximately 20 volts for powering the LEDs 103. The LEDs 103 can be connected in series, and the current through the LEDs 103 can be regulated to 200 mA. The LEDs 103 can be connected in series or parallel or a combination of both. Voltage to drive the LEDs 103 can be boosted to the appropriate voltage for the quantity and configuration of LEDs used.

A generally transparent potting or fill material 105 can fill in some or all the open spaces or gaps in the portable light source 100. The potting material 105 creates a generally seamless interface between the LEDs 103 and the outer shell 101 to enhance (e.g., maximize) the efficiency with which light is transmitted to the outer shell 101 and out of the light source 100. The potting material 105 can also be used to fill in the open upper end of the outer shell 101 to seal the light source 100 and the components therein. This arrangement can make the light source generally weatherproof, waterproof, dustproof, and/or resistant to vibration and/or static electricity. The potting material 105 can be a low viscosity silicone and/or another clear or highly translucent material. In other embodiments, the potting material 105 can be tinted or colored to change the color of the emitted light. The potting material 105 can be injected or otherwise directed into the light source 100 to fill the open spaces or gaps. In some embodiments, in addition to or in lieu of potting material 105 at the open upper end of the outer shell 101, a gasket (e.g., a silicone or rubber gasket) can cover and/or seal the open end of the outer shell 101 around the power button 106.

When fully assembled with all components (including the power button 106, a magnet 108, and other components described below), a representative light source 100 weighs approximately 80 grams. In other embodiments, the light source 100 can have a different weight, e.g., depending on the size and shape of the light source 100 or the mounting system used, which in turn can depend on the application for which the light source 100 is designed.

In operation, the light emitters 103 of the light source 100 emit light from inside the outer shell 101. The outer shell 101 guides the light around the internal opaque electronics (including, for example, the circuit board 102 and the battery 104) by acting as an optical waveguide or light pipe. However, because the outer shell 101 does not have perfect total internal reflection qualities, the guided light is emitted in a multi-directional manner out of the surface of the outer shell 101. For example, in a particular embodiment, light can be emitted in generally all directions from the light source 100. In other embodiments, light may be emitted in limited directions, for example, less than generally all directions, such as 180 degrees around the light source 100, or only on a desired side. The light source 100 takes advantage of Snell's law, wherein light traveling across an interface from a medium with a higher index of refraction to a medium having a lower index of refraction will refract away from a line normal to the interface. Accordingly, the light source 100 generally scatters light 120 after the light passes through the potting material 105 and outer shell 101.

In a representative embodiment, most or all of the internal components within the outer shell 101 and the potting material 105 can have reflective properties (e.g., diffuse reflective properties) so that light that does not initially escape the optical waveguide of the outer shell 101 is reflected and scattered back through and around the outer shell 101 and emitted outwardly in multiple directions. For example, in some embodiments of the present technology, the light source 100 includes a reflective surface 110 behind the LEDs 103 and/or a reflective wrap or cover 109 around the battery 104. Other reflective surfaces or coatings can be used on various internal components or electronics. Such reflective surfaces, e.g., the reflective cover 109, the reflective surface 110, and/or other reflective surfaces can serve to guide light back into and through the outer shell 101. In addition to, or in lieu of these reflective functions, in some embodiments, the reflective surface 110 and/or the reflective cover 109 may be white, red, or another color to provide an indication of what color the emitted light will be when the light source 100 is turned on. For example, the reflective cover 109, the reflective surface 110, and/or additional reflective coverings or surfaces on internal components can be red (e.g., to indicate a tail light function) or white (e.g., to indicate a headlight function).

In some embodiments of the present technology, the potting material 105 can be selected to have an index of refraction that approximately matches the index of refraction of the outer shell 101 so that more light is transmitted into the outer shell 101. In a particular embodiment for which the potting material 105 includes silicone, the index of refraction of the silicone is approximately 1.4, which is closer to the index of refraction of the outer shell 101 (e.g., if the outer shell 101 is polycarbonate, which has a refractive index of approximately 1.58) than that of air (which has an index of refraction of approximately 1). As a result, a silicone potting material 105 can act as an index-matching material to transmit more light into a polycarbonate outer shell 101 than would otherwise occur without an index-matching material.

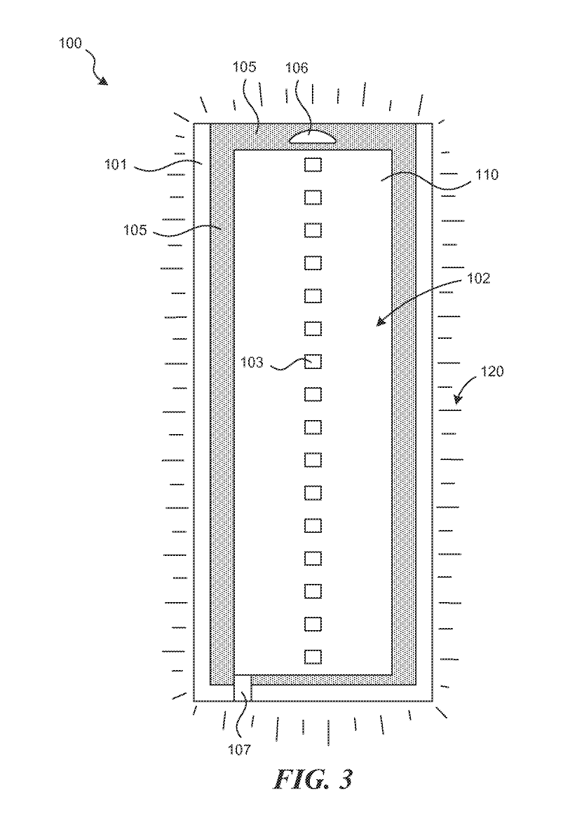

FIG. 2 is a cross-sectional view of the light source 100 taken generally along line 2-2 of FIG. 1. As shown in FIG. 2 and described above, the potting material 105 can fill open spaces or gaps between components of the light source 100. For example, the space between the battery 104 and the circuit board 102, as well as the space between the circuit board 102 (having LEDs 103) and the outer shell 101, can be filled with the potting material 105. Some internal sections may be void of the potting material, e.g., near battery ventilation holes or other components that could be damaged by potting.

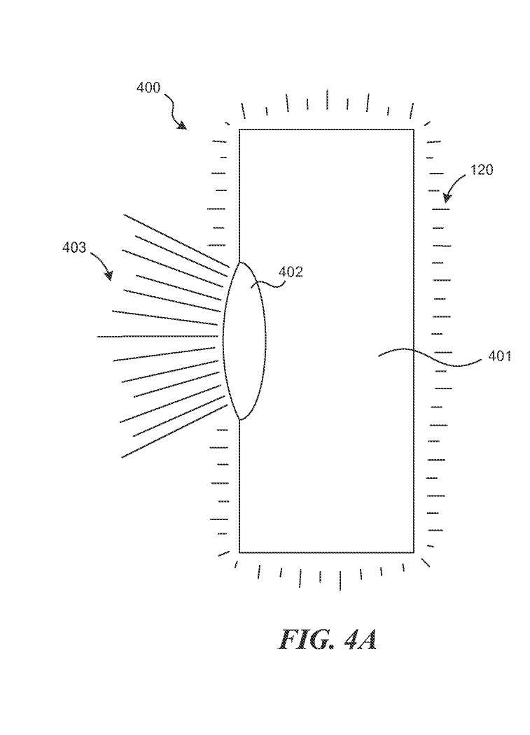

Much of the light from the LEDs 103 may be emitted from the side of the light source 100 having the circuit board 102 and the LEDs 103 (for example, the front side as shown in FIG. 3). The remaining light may reflect and refract within the light source 100 to bring light through and out of generally all sides of the potting material 105 and the outer shell 101. In this way, light emanates from the light source 100 to provide a to-be-seen function, enhancing visibility of the light source 100 from multiple sides and viewing angles.

The arrangement described herein can provide visibility that is on par with that of automotive lights. When used on a bicycle, this feature can provide a significant safety advantage providing visibility so others can see it from multiple angles or directions (e.g., any angle or direction), and at various times of day or night in a wide variety of weather conditions. The outer shell 101 can be partially coated and/or covered with a colored material, and/or the outer shell 101 can be pigmented with a coloring 111 to filter the light from one color, such as white, to another color, such as amber or red. A colored material can be a light filter such as a thin adhesive-backed colored material or a translucent coating. The coloring 111 (e.g., shown as a pigmentation of the outer shell 101 in FIG. 2), can be used on generally all or only a portion of the outer shell 101. For example, a yellow coloring, coating, and/or covering on the sides can be used to cause the light source 100 to provide yellow illumination to the sides and white illumination toward the front. In other embodiments, other configurations and color schemes can be used.

Referring now to FIG. 3, the light source 100 can have a single power or mode button 106 for controlling multiple functions of the light source 100. The button 106 can be a dome switch or a momentary switch, for example, and it can be contained within the light source 100 under a layer of the potting material 105, which can be compressed when the button 106 is pressed. In operation, pressing the button 106 can provide various programmed light patterns, brightness levels, or power modes. For example, a single click or press can cycle between programmed light patterns, such as flashing, pulsating, or solid light. A half-second press and release can cycle between programmed brightness levels. A longer press (for example, several seconds or more) and release can put the light source 100 into standby mode or a powered-off mode. In a particular embodiment, a single click can turn on the light source 100, and the light source 100 can be programmed to automatically return to the same pattern and brightness settings used when the light source 100 was last powered on. Accordingly, the light source 100 (e.g., the circuit board 102) can include a programmable non-volatile memory, or other suitable features to store the lighting parameter information when the light is powered off. In other embodiments, the light source 101 can include other arrangements, e.g., multiple buttons to control corresponding multiple modes, and/or a controller to cause the light source 100 to automatically enter a power-saving mode or low power state in which the light source 100 has reduced brightness to conserve battery power.

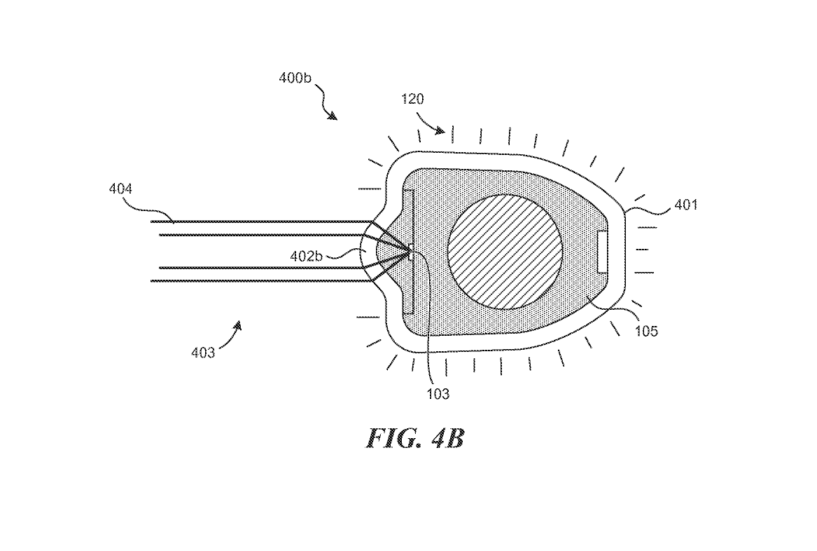

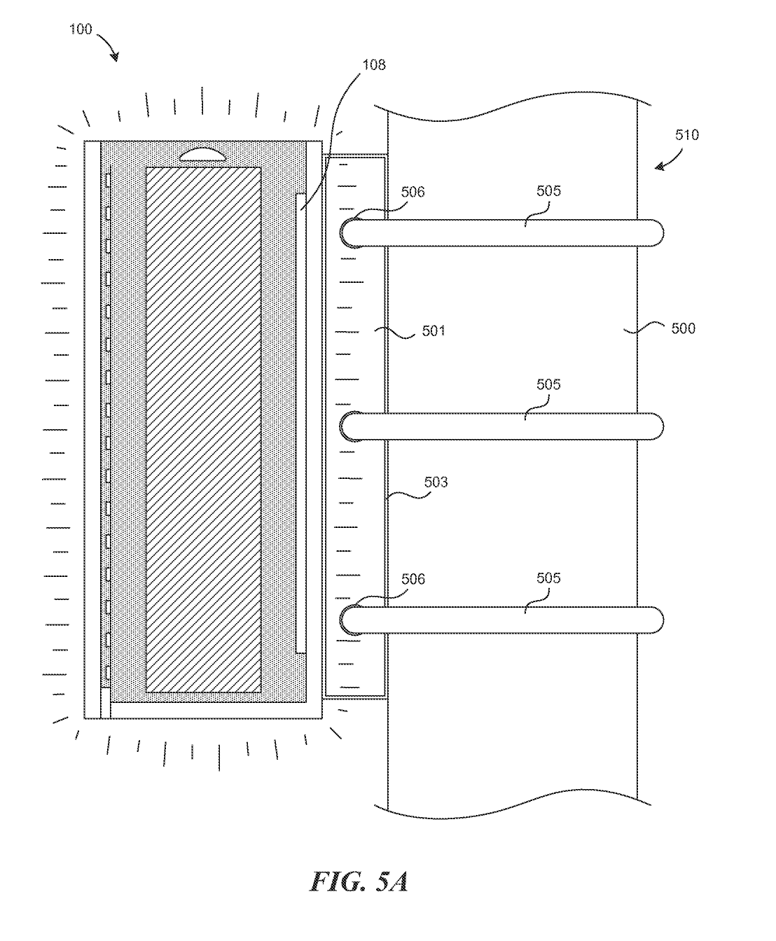

FIG. 4A depicts a light source 400 configured in accordance with another embodiment of the present technology. The light source 400 can include generally the same features as the light source 100, and can additionally include a lens 402 disposed on or formed as part of an outer shell 401 to provide a preferred direction or focus for some of the light from the LEDs 103. For simplicity, the internal details of the light source 400 are not shown in FIG. 4A. The lens 402 can be a Fresnel lens, a spherical lens, an aspherical lens, a cylindrical lens, or another suitable type of lens. The lens can serve for focusing the light or for diffusing and/or spreading the light more evenly throughout the device. Thus, as shown in FIG. 4A, projected or thrown light 403 can be more focused and can have a longer reach than the multi-directional light 120, which can be emitted from other surfaces or regions of the light source 400, as described above with reference to FIGS. 1-3. In yet another embodiment (not shown), a set of focused LEDs, or a combination of focused and unfocused LEDs, can be used in place of diffused-type LEDs. Thus, the light source 400 can provide multi-directional illumination for visibility via one or more LEDs in addition to focused illumination (via the same LEDs or one or more other LEDs) for longer-distance illumination. LEDs could also additionally be placed on the side for increased side illumination of the same or a different color.

FIG. 4B is a partially schematic, cross-sectional view of a portable light source 400b configured in accordance with another embodiment of the present technology. The light source 400b can include generally the same features as the light source 100, and it can additionally include a converging (e.g., focusing) lens 402b disposed on or formed as part of the outer shell 401. The remainder of the outer shell 401 can act as a diverging (e.g., spreading) lens and as an optical waveguide to spread light around the sides as described above with reference to FIGS. 1-3. The converging lens 402b can project light 403 with longer reach than multi-directional light 120. In a particular embodiment, if the potting material 105 and the material forming the lens 402b have similar indices of refraction, the light will travel generally straight through those materials until it is refracted out of the converging lens 402b in accordance with Snell's law (e.g., along a path similar to the path of light rays 404 emerging from the LED 103). In other embodiments with different materials, the light may travel along other suitable light paths.

### Mounting Systems for Portable Light Sources

Returning now to FIGS. 1-2, the portable light source 100 can include a magnet 108 for mounting the light source 100 to a supporting structure. The magnet 108 can be positioned within the outer shell 101 adjacent to an interior surface of the outer shell 101, or in other embodiments, the magnet 108 can be external to the outer shell 101. The magnet 108 can include a neodymium magnet (such as grade N52), or it can include another suitable type or grade of magnet. The magnet 108 may be magnetized through its thinnest dimension, normal to an outer surface of the light source 100 or the magnet 108. The magnet 108 can allow the light source 100 to be mounted to a surface or to another magnet, and it allows the light source 100 to be easily removed for safekeeping or storage. In other embodiments, other fastening systems are incorporated on the exterior of the light source 100, e.g., on the rear or sides of the outer shell 101. Suitable systems include snapping, locking, and/or other mechanisms.

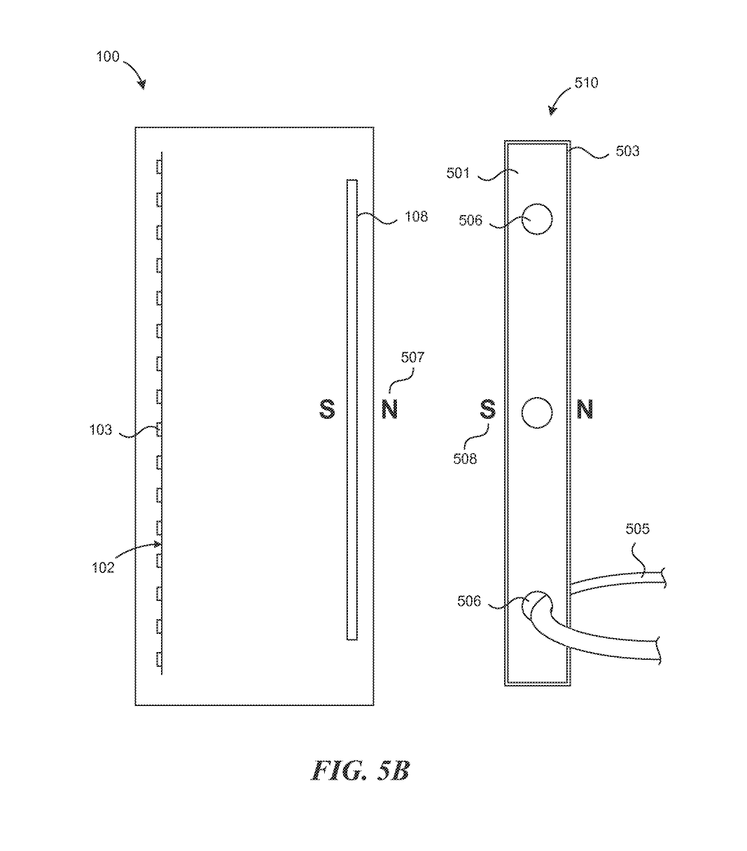

Referring now to FIG. 5A, the portable light source 100 can be mounted to a support structure 500 using a mounting system 510. In one embodiment, the mounting system 510 includes a mounting magnet 501 that is attached to the support structure 500 using fasteners 505, e.g., fastening bands, zip ties, and/or mounting straps or strips, which can pass through mounting openings or holes 506 in the mounting magnet 501 and wrap around the support structure 500. In other embodiments, the holes 506 can be formed as slots, or they can be formed as combinations of holes, slots, and/or other suitable shapes. In yet other embodiments, the mounting magnet 501 can be attached to the support structure 500 in other ways, e.g., with screws or adhesive. The mounting magnet 501 can be a neodymium magnet (such as grade N52), or it can be another suitable type or grade of magnet that is compatible with the light source magnet 108 described above. The mounting magnet 501 can also be magnetized through its thinnest dimension, normal to its length. The magnet 108 of the light source 100 can be polarized so as to be attracted toward the mounting magnet 501 to form a strong and accurately-aligned mounting connection that resists weather and vibration. The strengths of the magnetic fields provided by the magnets 108 and 501 can force the light source 100 to align relative to the mounting system 510 the same way each time the light source 100 is re-attached to the mounting system 510. This arrangement can provide a simple way to position the light source 100 repeatedly and accurately.

The mounting magnet 501 can be at least partially covered with a soft or resilient overmold or covering 503 to protect any underlying surfaces from scratching or corrosion. For example, the covering 503 can be formed from rubber, neoprene, vinyl, or similar materials. The covering 503 can also protect the mounting magnet 501 itself from corrosion or oxidation, and it can prevent the light sources from sliding with respect to the mounting magnet 501.

FIG. 5B shows selected details of an embodiment of the mounting system 510. The light source magnet 108 can be configured to have a magnetic pole 507. Note that magnetic pole 507 is shown as N (i.e., north, as opposed to south, or “S”) in FIG. 5B, but in other embodiments, the polarity of the magnet 108 can be reversed. The magnet 108 can be used to mount the light source 100 to various metallic or magnetic objects. In other embodiments, the magnetic mounting components of the present technology can be used to limit or control the possible mounting configurations of the light source 100. For example, the mounting magnet 501 can be attached to the support structure 500 (not shown in FIG. 5B) in such a way as to only have one magnetic pole 508 facing away or outwardly from the support structure 500. In such a configuration, the light source magnet 108, having its own magnetic pole 507 facing away or outwardly from the light source 100, will be mutually attracted toward the mounting magnet 501 if the magnetic polarities 507 and 508 are opposite each other. Conversely, if the outwardly-facing magnetic polarities 507 and 508 are the same, the magnets 108 and 501 will mutually repel each other. Consequently, selected arrangements or orientations of the magnets 108 and 501 can be used to mount or prevent mounting of the light source 100 to a support structure 500.

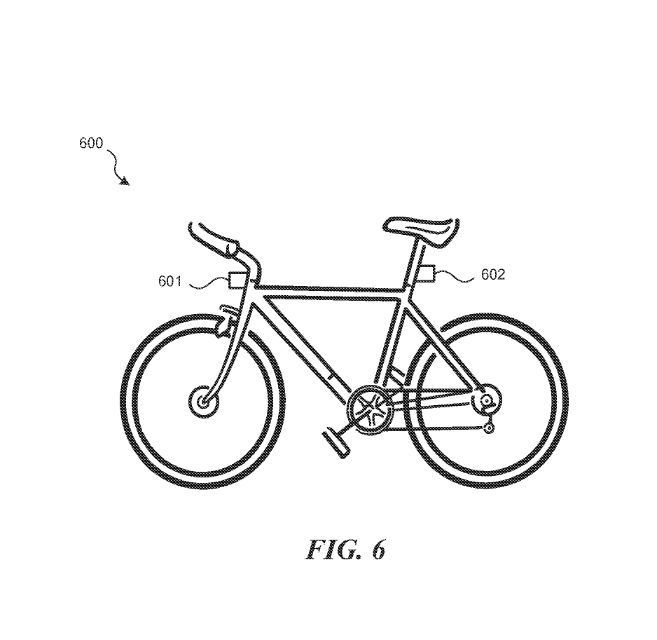

The foregoing aspect of the present technology can prevent accidental or purposeful application of certain light sources to certain support structures. For example, in the arrangement shown in FIG. 6, a bicycle 600 is fitted with a front-mounted light source 601 and/or a rear-mounted light source 602. The front-mounted light source 601 can be white, while the rear-mounted light source 602 can be red or amber. In a particular arrangement, and with additional reference to FIG. 5B, the front-mounted light source 601 can be similar to the light source 100 and can have an outwardly facing magnetic polarity 507 that is opposite the outwardly facing magnetic polarity 508 of a corresponding front-mounted mounting magnet 501, so that magnets 501 and 108 attract toward each other to facilitate mounting. Conversely, the front-mounted light source 601 can have the same outwardly facing magnetic polarity 507 as a mounting magnet 501 on the rear of the bicycle 600, which repels the front-mounted light source 601 from the rear of the bicycle 600 to prevent incorrect mounting (if a white light is undesirable on the rear of the bicycle 600, for example). In other embodiments, mounting magnet 501 can be omitted and magnet 108 carried by the light source can be attracted directly toward support structures or bicycle parts made of steel or other materials to which a magnet can be attracted.

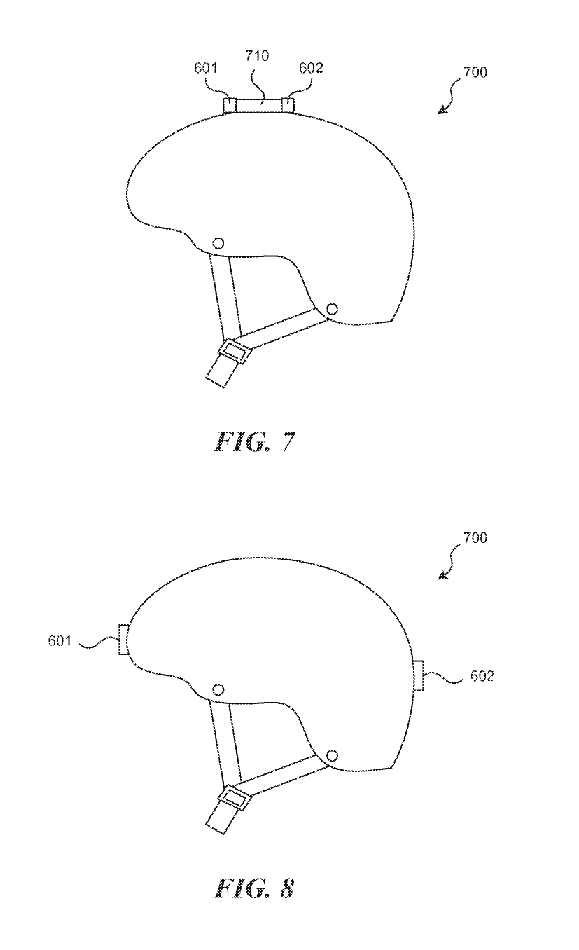

A light source, such as the light sources 100 or 400 as described herein, can also be used to provide illumination on a helmet 700, for example, as shown in FIGS. 7 and 8. A front-mounted light source 601 can be mounted toward the front of the helmet 700 and a rear-mounted light source 602 can be mounted toward the rear of the helmet 700. A single mounting system 710 can be attached to the helmet 700 to carry both light sources 601 and 602, using magnets of opposite polarity disposed on opposite sides of the mounting system 710 in a similar fashion as the magnets of opposite polarity disposed on opposite sides of the bicycle 600 described above. In some embodiments, the single mounting system 710 need not have its own magnets and it may simply be metallic or capable of attracting a magnet.

From the foregoing, it will be appreciated that specific embodiments of the disclosed technology have been described herein for purposes of illustration, but that various modifications may be made without deviating from the technology. For example, the light source 100 can use other suitable kinds of potting material 105 or light emitting devices 103, and/or other suitable shapes or arrangements of the outer shell 101 (e.g., flat or rectangular arrangements). In other embodiments, the light source can be disposable and can use non-rechargeable batteries 104, and/or the battery 104 can be serviceable or replaceable. The magnets 108 and 501 can be electromagnetic devices rather than permanent magnets. The light emitting device can include an LED in some embodiments, and can include other devices (e.g., incandescent or fluorescent bulbs) in other embodiments. Embodiments of the present technology can be mounted or attached to hats, backpacks, SCUBA gear, skydiving equipment, clothing, search and rescue gear, safety vests, road hazard equipment or vehicles, and/or other objects where improved visibility is desired.

In yet other embodiments of the technology, the outer shell (e.g., outer shell 101) can be formed around the internal components. For example, the light source 100 can be formed by placing the internal components (e.g., the circuit board 102, the battery 104, the power button 106, the charging interface 107, and/or the magnet 108) in a mold and filling the mold with potting material (e.g., 105) or another suitable material to contain the components and provide light distribution. The assembly can be cured or otherwise finished to form the light source. In some embodiments, the components can be partially over-molded. For example, the charging interface 107 and/or other components may be partially overmolded to accommodate access to the components, such as access to the charging interface 107 by external charging components. In other embodiments, there can be a hatch to remove and replace the battery 104 and/or a hatch to access the charging interface 107. In further embodiments, a mounting stud or other suitable attachment points can extend from the light source 100 (e.g. from the cured potting material).

Certain aspects of the technology described in the context of particular embodiments may be combined or eliminated in other embodiments. For example, the present technology can be practiced in connection with devices that do not have potting material 105 and/or a generally transparent outer shell. In yet other embodiments, the present technology can be practiced in connection with mounting systems or arrangements that do not use mounting straps 505 and/or magnets 108 and/or 501. The circuit board 102 may be omitted in favor of another support for the LEDs 103. The button 106 may provide more or fewer modes, such as simply an on/off mode.

Further, while advantages associated with certain embodiments of the disclosed technology have been described in the context of those embodiments, other embodiments may also exhibit such advantages, and not all embodiments need necessarily exhibit such advantages to fall within the scope of the technology. Accordingly, the disclosure and associated technology can encompass other embodiments not expressly shown or described herein.

I claim:

1. A portable light source, comprising:
an elongated generally transparent outer shell;
at least one light-emitting device positioned within the outer shell; and
a battery positioned within the outer shell and operatively coupled to the at least one light-emitting device; wherein
the outer shell is positioned to guide light from the light-emitting device around the outer shell and out of an external surface of the outer shell.

2. The portable light source of claim 1, further comprising a generally transparent potting material positioned in spaces between the battery, the outer shell, and the at least one light-emitting device.

3. The portable light source of claim 2 wherein the potting material includes silicone.

4. The portable light source of claim 1, further comprising a generally reflective cover disposed around the battery.

5. The portable light source of claim 1 wherein the outer shell includes at least one lens positioned to focus at least a portion of the light.

6. The portable light source of claim 1 wherein the generally transparent outer shell includes polycarbonate.

7. The portable light source of claim 1 wherein the at least one light-emitting device is a light-emitting diode.

8. The portable light source of claim 1 wherein the at least one light-emitting device is mounted on a circuit board, and wherein at least a portion of the circuit board includes a reflective surface.

9. The portable light source of claim 1, further comprising a button interface including a single button configured to select a lighting mode of the at least one light-emitting device.

10. The portable light source of claim 9 wherein the mode is at least one of a light pattern, a brightness level, a standby mode, and a power mode.

11. The portable light source of claim 1, further comprising a charging interface.

12. The portable light source of claim 11 wherein the charging interface is a universal serial bus port.

13. The portable light source of claim 11 wherein the charging interface is an inductive charging interface.

14. The portable light source of claim 1 wherein the battery is rechargeable.

15. The portable light source of claim 1, further comprising a mounting magnet.

16. A mounting system for a portable light source, the mounting system comprising:
a first magnet having a first magnetic pole with a first magnetic polarity and being attachable to a first support structure such that the first magnetic pole is oriented to face away from the first support structure; and
a second magnet having a second magnetic pole with a second magnetic polarity opposite the first magnetic polarity, the second magnet being attached to the portable light source; wherein
the second magnetic pole is configured to attract toward the first magnetic pole to mount the light source to the first support structure.

17. The mounting system of claim 16, further comprising a third magnet having a third magnetic pole with a third magnetic polarity and being attached to a second support structure such that the third magnetic pole is oriented to face away from the second support structure, the third magnetic polarity being the same as the second magnetic polarity, wherein the third magnetic pole is configured to repel the second magnetic pole to prevent the light source from being mounted to the second support structure.

18. The mounting system of claim 17 wherein the first support structure is located toward a front end of a bicycle and the second support structure is located toward a rear end of the bicycle.

19. The mounting system of claim 18 wherein the portable light source is a first portable light source which emits generally white light, and wherein the system further comprises a second portable light source which emits generally red or amber light.

20. The mounting system of claim 17 wherein the first support structure is a forward portion of a helmet and the second support structure is a rearward portion of the helmet.

21. The mounting system of claim 16 wherein the first magnet is attached to the first support structure via mounting straps.

22. The mounting system of claim 16 wherein the first magnet has holes positioned to receive mounting straps.

23. The mounting system of claim 16, further comprising a resilient covering over at least part of the first magnet.
